(19) United States
(12) Patent Application Publication
(10) Pub. No.: US 2007/0172673 A1
(43) Pub. Date: Jul. 26, 2007

(54) Coating agents and plastic body with an antigraffiti effect and method for the production thereof

(75) Inventors: Patrick Becker, Muehltal (DE); Thomas Hasskerl, Kronberg (DE); Rolf Neeb, Pfungstadt (DE); Ghirmay Seyoum, Egelsbach (DE); Reiner Lingelbach, Muenster (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Roehm GMBH & Co.KG, Darmstadt (DE)

(21) Appl. No.: 10/555,772

(22) PCT Filed: Mar. 25, 2004
(86) PCT No.: PCT/EP04/03157

§ 371 Date: Oct. 24, 2006

(30) Foreign Application Priority Data
May 14, 2003 (DE) 103 21 799.1

(51) Int. Cl. B32B 9/04; C09D 5/00

(52) U.S. Cl. 428/447; 106/2; 106/287.16; 106/287.18

(57) ABSTRACT

The invention relates to coating agents having an antigraffiti effect. Said coating agents can be obtained according to a method consisting in condensing the organic silicon compounds of general formula (I): R¹ₙSIX₄₋ₙ, wherein R¹ represents a group comprising 1-20 carbon atoms, X represents an alkoxy radical having 1-20 carbon atoms or halogen and n represents an even number between 0-3. The different radicals X or R¹ can be identical or different and/or the precondensates can be obtained from said components. At least 50 wt. % of the silicon compounds, in relation to the total weight of the used silicon compounds, is represented by the formula R¹SiX₃, wherein R¹ and X have the above-cited meaning, in order to form polysiloxanes until the ratio of signals R¹SiO(OH) and signals R¹SiO_{1,5} measured by NMR-spectroscopy ranges from 0.6-4, and by adding compounds of formula (II) (R″)ᵤSi(R′)ₜ(OR)₍₄₋ₜ₋ᵤ₎ to said polysiloxane mixture, wherein R represents a group comprising 1-20 carbon atoms having at least 3 fluoro atoms. U is 1 or 2 and t is 0 or 1, R and R′ are identical or different and represent a group comprising 1-20 carbon atoms. The also relates to plastic bodies which have coating which can be obtained by means of the coating agents.

The present invention relates to coating agents and plastic bodies with an antigraffiti effect and also to methods for the production of these plastic bodies.

When construction elements, glasshouses for example, or noise barrier walls are daubed and sprayed without authorization, these articles become unesthetic and in many cases are no longer in accordance with their owners' sense of taste. Many developments therefore aim to lower the capacity of these articles to be wet by such graffiti daubings. Treatments aiming to reduce the adhesion of graffiti are known in the art, and generally involve the surface being rendered hydrophobic.

In order to imbue surfaces with hydrophobic properties a range of possibilities are known from the prior art. For the purpose of achieving surfaces with long-term stability, UV resistance, and oil and water repellency, the use of fluorinated compounds has been described (e.g. WO 92/21729). On account of their entirely desirable surface properties, such fluorinated and perfluorinated compounds and/or polymers frequently possess only low or poor adhesion properties. As a result of this, lasting attachment to a variety of substrates is difficult to achieve or achievable only at increased cost and inconvenience. Further disadvantages of these compounds lie in their lack of transparency and in their price, which is high—uneconomically so for many applications. For many applications, furthermore, they are of inadequate hardness, as is known, for example, in connection with polyfluoroethylene coated pots and pans.

A further possibility for rendering surfaces hydrophobic is provided by the silane chemistry. Silanes of this kind with fluorinated side chains are used predominantly in order to surface-fluorinate glass and ceramic substrates (e.g., DE 100 51 182).

These fluorosilanes have found application more recently as coats, containing a number of layers of molecules, on sanitary ceramic and for rendering concrete hydrophobic, the effective dirt repellency effect and the transparency of these fluorosilanes being overall deserving of emphasis.

A disadvantage, however, is that these compounds often display only inadequate chemical resistance and mechanical abrasion resistance. Furthermore, there is also a problem of adhesion to the substrate. Hence the influence of the fluorinated side chains also leads to a reduced surface energy on the substrate side. As a result, depending on substrate, poor adhesion or else no adhesion at all is obtained. Additionally, as a result of the uncontrolled orientation of the fluorinated side chains both toward the substrate and toward the surface, the desired effect of the coating is reduced or lost completely (e.g., Dieter Stoye, Werner Freitag, Weinheim: WILEY-VCH Verlag GmbH, 1998, 2^{nd} revised edition, page 28).

A range of coatings having antigraffiti properties are known (e.g., EP 0628610A1, EP 0628614A1, EP 0587667B1, DE 19955047A1, DE 100 51 182). For a variety of reasons, however, they prove unsuitable for the requirements recited above.

In EP 0628610A1 and EP 0628614A1, UV-curing coating materials are used. However, these materials have production costs which are too expensive (curing under nitrogen) for their application to large areas, and they are therefore unsuitable for the application of large panels, e.g., in the sector of noise barrier walls. Moreover, the weathering stability of such coatings is insufficient for many demanding applications.

EP 0587667B1 describes coating agents which comprise silanes having nonhydrolyzable flouroalkyl groups. In this case, first of all, a polysiloxane is formed by condensation, the fluorinated silanes being added only when the water content of the system is not more than 5% by weight.

The molar mass of these condensates when the fluorinated silanes are added is necessarily very high, the examples giving rise arithmetically to an infinite molecular weight of the condensates when the fluorinated silanes are added. The need to use polysiloxanes of high molecular mass is explicitly set out in that publication. Preference is given to using 3-methacryloyloxypropyltrimethoxysilane (MEMO) condensates, which are then either radiation-cured, thermally cured or radiation-cured and thermally cured. Radiation curing is found unsuitable for the target applications, for the reasons given above. In the case of thermal curing there is a possibility that not all of the C—C double bonds will be consumed by reaction. The result of that, however, is a reduced weathering stability.

In DE 19955047 A1, nitrogen-containing compounds are used. In outdoor weathering, however, as the skilled worker is aware, these compounds lead to yellowing.

In DE 100 51 182 the desired antigraffiti effects are obtained through the use of nanoparticles. As the skilled worker is aware, however, the incorporation of nanoparticles into coating systems is frequently accompanied by the formation of agglomerates. In that case there is a possibility of particles forming which are larger than 400 nm and which therefore reduce the transparency of the substrate.

A problematic aspect of these prior-art plastic bodies, therefore, is their low scratch resistance or their low weathering stability. Environmental effects cause the coating to yellow over time, so that the esthetic impression of coated articles no longer meets the requirements imposed. Moreover, cleaning operations may wear down the coating, so that the antigraffiti effect diminishes.

In view of the herein indicated and discussed prior art, therefore, it was an object of the present invention to specify coating agents for plastics substrates that allow scratch-resistant and weathering-stable antigraffiti treatment.

A further aim of the present invention was to provide coating agents with an antigraffiti effect which do not adversely alter the qualities of the substrate.

Thus, the spray paints used to produce graffiti ought, as a result of an inventive antigraffiti treatment, to adhere no longer, or only weakly, to the plastic body, and sprayed substrates ought to be easy to clean, so that, for example, water, cloths, surfactant, high-pressure cleaners, and mild solvents are sufficient.

The antigraffiti-effect plastic bodies obtainable by the coating agents of the invention ought to be transparent, scratch-resistant, long-lived, and weathering-stable.

It was therefore an objective of the present invention, moreover, to provide antigraffiti-effect plastic bodies which do not loose their antigraffiti effect and do not yellow even over a relatively long time period.

Additionally the invention was based on the object of providing scratch-resistant, antigraffiti-effect plastic bodies which are particularly easy to produce. Thus, for the production of the plastic bodies, it ought to be possible in particular to use substrates obtainable by extrusion, by injection molding, and by casting methods.

In addition, therefore, it was an object of the present invention to provide antigraffiti-effect plastic bodies which can be produced inexpensively.

A further object of the present invention was to specify scratch-resistant, anti-graffiti-effect plastic bodies which exhibit outstanding mechanical properties. This quality is particularly important for applications in which the plastic body is to have a high stability toward impact exposure.

Furthermore, the plastic bodies with an antigraffiti effect ought to have particularly good visual qualities.

These objects, along with others which, although not explicitly stated, can be inferred as self-evident from the circumstances discussed herein, or result automatically from them, are achieved by means of the coating agents described in claim 1. Advantageous modifications of the coating agents of the invention are protected in the subclaims appendant to claim 1.

In respect of the plastic bodies, claim 15 offers an achievement of the objects set out in more detail above.

With regard to production methods, claim 26 affords an achievement of the underlying object.

By subjecting organosilicon compounds of the general formula (I)
R¹ₙSiX₄₋ₙ (I),
in which R¹ is a group containing 1 to 20 carbon atoms, X is an alkoxy radical having 1 to 20 carbon atoms or a halogen, and n is an integer from 0 to 3, it being possible for different radicals X or R¹ in each case to be identical or different, and/or precondensates obtainable therefrom, at least 50% by weight of the silicon compounds, based on the total weight of the silicon compounds employed, being representable by the formula R¹SiX₃, in which R¹ and X are as defined above, to condensation to give polysiloxanes, until the ratio of R¹SiO(OH) to R¹SiO_{1.5} signals, measured by NMR spectroscopy, is in the range from 1 to 4, and adding to this polysiloxane mixture compounds of the formula (II)
(R″)ᵤSi(R′)ₜ(OR)₍₄₋ₜ₋ᵤ₎ (II),
in which R″ is a group containing 1 to 20 carbon atoms and having at least 3 fluorine atoms, u is 1 or 2 and t is 0 or 1, R and R′ are identical or different and are a group containing 1 to 20 carbon atoms, success is achieved in providing coating agents with an antigraffiti effect with which plastic bodies can be obtained that have a particularly high scratch resistance.

As a result of the measures according to the invention the following advantages in particular, among others, are obtained:
as a result of the coating agents of the present invention, plastic bodies are obtainable which are highly insensitive to the formation of scratches on the surface.
plastic bodies provided with coatings according to the invention exhibit a high resistance toward UV irradiation.
moreover, plastic bodies coated in accordance with the invention exhibit a particularly low surface energy.
furthermore, the plastic bodies and the coating agents of the present invention can be produced particularly inexpensively.
the scratch-resistant plastic bodies of the present invention can be adapted to particular requirements. In particular it is possible to vary the size and shape of the plastic body within wide ranges without detriment to the scratch resistance or the antigraffiti quality as a result.
furthermore, the present invention also provides plastic bodies having outstanding visual qualities.
the scratch-resistant plastic bodies of the present invention have good mechanical properties.

Coating agents of the present invention are prepared by subjecting organosilicon compounds of the general formula (I)
R¹ₙSiX₄₋ₙ (I),
in which R¹ is a group containing 1 to 20 carbon atoms, X is an alkoxy radical having 1 to 20 carbon atoms or a halogen, and n is an integer from 0 to 3, it being possible for different radicals X or R¹ in each case to be identical or different, and/or precondensates obtainable therefrom, to condensation to give polysiloxanes.

The expression “a group containing 1 to 20 carbon” identifies radicals of organic compounds having 1 to 20 carbon atoms. It embraces alkyl, cycloalkyl, aromatic groups, alkenyl groups and alkynyl groups having 1 to 20 carbon atoms, and also heteroaliphatic and heteroaromatic groups which besides carbon atoms and hydrogen atoms contain, in particular, oxygen, nitrogen, sulfur, and phosphorus atoms. Said groups may be branched or unbranched, and the radical R¹ can be substituted or unsubstituted. The substituents include, in particular, halogens, groups containing 1 to 20 carbon, nitro, sulfonic acid, alkoxy, cycloalkoxy, alkanoyl, alkoxycarbonyl, sulfonic ester, sulfinic acid, sulfinic ester, thiol, cyanide, epoxy, (meth)acryloyl, amino, and hydroxyl groups. In the context of the present invention the expression “halogen” denotes a fluorine, chlorine, bromine or iodine atom.

The preferred alkyl groups include the methyl, ethyl, propyl, isopropyl, 1-butyl, 2-butyl, 2-methylpropyl, tert-butyl, pentyl, 2-methylbutyl, 1,1-dimethylpropyl, hexyl, heptyl, octyl, 1,1,3,3-tetramethylbutyl, nonyl, 1-decyl, 2-decyl, undecyl, dodecyl, pentadecyl and the eicosyl group.

The preferred cycloalkyl groups include the cyclopropyl, cyclobutyl, cyclopentyl, cyclohexyl, cycloheptyl and the cyclooctyl group, which if desired are substituted by branched or unbranched alkyl groups.

The preferred alkenyl groups include the vinyl, allyl, 2-methyl-2-propene, 2-butenyl, 2-pentenyl, 2-decenyl and the 2-eicosenyl group.

The preferred alkynyl groups include the ethynyl, propargyl, 2-methyl-2-propyne, 2-butynyl, 2-pentynyl and the 2-decynyl group.

The preferred alkanoyl groups include the formyl, acetyl, propionyl, 2-methylpropionyl, butyryl, valeroyl, pivaloyl, hexanoyl, decanoyl and the dodecanoyl group.

The preferred alkoxycarbonyl groups include the methoxycarbonyl, ethoxycarbonyl, propoxycarbonyl, butoxycarbonyl, tert-butoxycarbonyl, hexyloxycarbonyl, 2-methylhexyloxycarbonyl, decyloxycarbonyl or dodecyloxycarbonyl group.

The preferred alkoxy groups include the methoxy, ethoxy, propoxy, butoxy, tert-butoxy, hexyloxy, 2-methylhexyloxy, decyloxy or dodecyloxy group.

The preferred cycloalkoxy groups include cycloalkoxy groups whose hydrocarbon radical is one of the abovementioned preferred cycloalkyl groups.

The preferred heteroaliphatic groups include the abovementioned preferred alkyl and cycloalkyl radicals in which at least one carbon unit has been replaced by O, S or a group NR⁸ and R⁸ is hydrogen, an alkyl group containing 1 to 6 carbon atoms, an alkoxy group containing 1 to 6 carbon atoms or an aryl group.

In accordance with the invention aromatic groups denote radicals of mono or polycyclic aromatic compounds having preferably 6 to 14, in particular 6 to 12, C atoms. Heteroaromatic groups identify aryl radicals in which at least one CH group has been replaced by N and/or at least two adjacent CH groups have been replaced by S, NH or O. Inventively preferred aromatic or heteroaromatic groups derive from benzene, naphthalene, biphenyl, diphenyl ether, diphenylmethane, diphenyl dimethylmethane, bisphenone, diphenyl sulfone, thiophene, furan, pyrrole, thiazole, oxazole, imidazole, isothiazole, isoxazole, pyrazole, 1,3,4-oxadiazole, 2,5-diphenyl-1,3,4-oxadiazole, 1,3,4-thiadiazole, 1,3,4-triazole, 2,5-diphenyl-1,3,4-triazole, 1,2,5-triphenyl-1,3,4-triazole, 1,2,4-oxadiazole, 1,2,4-thiadiazole, 1,2,4-triazole, 1,2,3-triazole, 1,2,3,4-tetrazole, benzo[b]thiophene, benzo[b]furan, indole, benzo[c]thiophene, benzo[c]furan, isoindole, benzoxazole, benzothiazole, benzimidazole, benzisoxazole, benzisothiazole, benzopyrazole, benzothiadiazole, benzotriazole, dibenzofuran, dibenzothiophene, carbazole, pyridine, pyrazine, pyrimidine, pyridazine, 1,3,5-triazine, 1,2,4-triazine, 1,2,4,5-triazine, quinoline, isoquinoline, quinoxaline, quinazoline, cinnoline, 1,8-naphthyridine, 1,5-naphthyridine, 1,6-naphthyridine, 1,7-naphthyridine, phthalazine, pyridopyrimidine, purine, pteridine or 4H-quinolizine, diphenyl ether, anthracene and phenanthrene.

Preferred radicals R¹ can be represented by the formula (III),
—(CH₂)ₘNH—[(CH₂)ₙ—NH]ₚH (III),
in which m and n is a number from 1 to 6, and p is zero or one,
or the formula (IV) 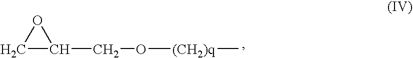
in which q is a number from 1 to 6, or the formula (V) 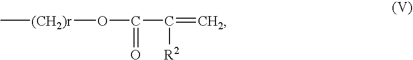
in which R² is methyl or hydrogen and r is a number from 1 to 6.

With very particular preference the radical R¹ is a methyl or ethyl group.

With regard to the definition of the group X in formula (I), with respect to the alkoxy group having 1 to 20 carbon atoms and also to the halogen, reference may be made to the definition given above, the alkyl radical of the alkoxy group likewise being preferably representable by the formulae (III), (IV) or (V) set out above. Preferably the group X is a methoxy or ethoxy radical or a bromine or chlorine atom.

These compounds can be used individually or as a mixture in order to produce siloxane coating materials.

Depending on the number of halogens or of alkoxy groups attached to the silicon via oxygen, chains or branched siloxanes are formed by hydrolysis and/or condensation from the silane compounds of the formula (I).

In accordance with the invention at least 50% by weight, preferably at least 60% by weight, in particular at least 80% by weight of the silane compounds used contain at least three alkoxy groups or halogen atoms, based on the weight of the condensable silanes.

Tetraalkoxysilanes comprise tetramethoxysilane, tetraethoxysilane, tetra-n-propoxysilane, tetraisopropoxysilane and tetra-n-butoxysilanes; trialkoxysilanes comprise methyltrimethoxysilane, methyltriethoxysilane, ethyltrimethoxysilane, n-propyltrimethoxysilane, n-propyltriethoxysilane, isopropyltriethoxysilane, isopropyltrimethoxysilane, isopropyltripropoxysilane, n-butyltrimethoxysilane, n-butyltriethoxysilane, n-pentyltrimethoxysilane, n-hexyltrimethoxysilane, n-heptyltrimethoxysilane, n-octyltrimethoxysilane, vinyltrimethoxysilane, vinyltriethoxysilane, cyclohexyltrimethoxysilane, cyclohexyltriethoxysilane, phenyltrimethoxysilane, 3-chloropropyltrimethoxysilane, 3-chloropropyltriethoxysilane, 3,3,3-trifluoropropyltrimethoxysilane, 3,3,3-trifluoropropyltriethoxysilane, 3-aminopropyltrimethoxysilane, 3-aminopropyltriethoxysilane, 2-hydroxyethyltrimethoxysilane, 2-hydroxyethyltriethoxysilane, 2-hydroxypropyltrimethoxysilane, 2-hydroxypropyltriethoxysilane, 3-hydroxypropyltrimethoxysilane, 3-hydroxypropyltriethoxysilane, 3-mercaptopropyltrimethoxysilane, 3-mercaptopropyltriethoxysilane, 3-isocyanatopropyltrimethoxysilane, 3-isocyanatopropyltriethoxysilane, 3-glycidyloxypropyltrimethoxysilane, 3-glycidyloxypropyltriethoxysilane, 2-(3,4-epoxycyclohexyl)ethyltrimethoxysilane, 2-(3,4-epoxycyclohexyl)ethyltriethoxysilane, 3-(meth)acryloyloxypropyltrimethoxysilane, 3-(meth)acryloyloxypropyltriethoxysilane, 3-ureidopropyltrimethoxysilane and 3-ureidopropyltriethoxysilane;

dialkoxysilanes comprise dimethyldimethoxysilane, dimethyldiethoxysilane, diethyldimethoxysilane, diethyldiethoxysilane, di-n-propyldimethoxysilane, di-n-propyldiethoxysilane, di-isopropyldimethoxysilane, di-isopropyldiethoxysilane, di-n-butyldimethoxysilane, di-n-butyldiethoxysilane, di-n-pentyldimethoxysilane, di-n-pentyldiethoxysilane, di-n-hexyldimethoxysilane, di-n-hexyldiethoxysilane, di-n-peptyldimethoxysilane, di-n-peptyldiethoxysilane, di-n-octyldimethoxysilane, di-n-octyldiethoxysilane, di-n-cyclohexyldimethoxysilane, di-n-cyclohexyldiethoxysilane, diphenyldimethoxysilane and diphenyldiethoxysilane.

Particular preference is given to methyltrimethoxysilane, methyltriethoxysilane, ethyltrimethoxysilane and ethyltriethoxysilane. According to one particular aspect of the present invention the fraction of these particularly preferred alkyltrialkoxysilanes is at least 80% by weight, in particular at least 90% by weight, based on the weight of the silane compounds used.

It is essential to the invention that the silane compounds set out above are condensed to polysiloxanes before the fluorinated silanes of formula (II) are added to the mixture. The polysiloxanes to which compounds of the formula (II) are added comprise R¹SiO(OH) and R¹SiO_{1.5} groups, which can be obtained by hydrolysis and subsequent complete condensation for R¹SiO_{1.5} groups or partial condensation for R¹SiO(OH) groups, from compounds of the formula R¹SiX₃ of formula (I). For the success of the present invention it is essential that the ratio of R¹SiO(OH) to R¹SiO_{1.5} signals, measured by NMR spectroscopy, is in the range from 0.6 to 4, preferably 0.8 to 3.5, in particular 0.9 to 3, and more preferably 1 to 2.5. This ratio arises from the integrals of the signals.

The fraction of these groups can be obtained by NMR spectroscopy, with the R¹SiO_{1.5} groups and the R¹SiO(OH) groups being assignable in accordance with F. Brunet, Journal of Non-Crystalline Solids 231 (1998), 58-77. The mixture of the polysiloxanes that is formed by hydrolysis of the silanes can be analyzed in bulk (without solvent) without a deuterium lock by means of ²⁹Si NMR (gated decoupling, 5 s delay).

The silane compounds set out above can be used individually or as a mixture. Furthermore, it is also possible to use precondensates, in which case the ratio of R¹SiO(OH) to R¹SiO_{1.5} signals present in the precondensate, measured by NMR spectroscopy, is not more than 4.

The polysiloxanes to which compounds of the formula (II) are added preferably have a hydroxyl group content in the range from 17% to 30%, in particular 19% to 22% by weight, based on the number of possible hydroxyl groups which can result at maximum from the hydrolysis of compounds of the formula (I).

For the condensation of the aforementioned silanes and/or precondensates to give the polysiloxanes to which compounds of the formula (II) are added it is customary to add condensation catalysts and also water in sufficient amount to form polysiloxanes which contain R¹SiO(OH) groups and R¹SiO_{1.5} groups, the ratio of R¹SiO(OH) groups to R¹SiO_{1.5} groups, measured by NMR spectroscopy, being in the range from 1 to 4.

Suitable curing catalysts include acids, especially Brönsted acids, and also bases. The bases include, in particular, organic bases, especially amines that are soluble in the reaction medium, particularly the aforementioned silanes containing amino groups, such as 3-aminopropyltriethoxysilane, for example, and triethylamine, and also soluble alkanolamines; and inorganic bases, especially ammonia, alkali metal and alkaline earth metal hydroxides, particularly NaOH, KOH and Ca(OH)₂.

Examples of acids which can be added include inorganic acids, such as hydrochloric acid, sulfuric acid, phosphoric acid, nitric acid, etc., or organic acids, such as carboxylic acids, formic acid and acetic acid for example, organic sulfonic acids, etc., or acidic ion exchangers, the pH of the hydrolysis reaction being generally between 2 and 4.5, preferably 3.

According to one particular aspect of the present invention, water-containing coating agents are prepared from the abovementioned silane compounds by hydrolyzing organosilicon compounds with an amount of water sufficient for the hydrolysis, i.e., >0.5 mol of water per mole of the groups intended for hydrolysis, such as alkoxy groups, for example, preferably under acid catalysis.

In general an increase in temperature is apparent after the reactants have been combined. In certain cases it may be necessary to supply heat from externally in order to initiate the reaction: for example, by heating the batch to 40-50° C. In general, care is taken to ensure that the reaction temperature does not exceed 55° C. The reaction time is generally relatively short; normally it is less than one hour —45 minutes, for example.

The condensation reaction can be terminated, for example, by cooling to temperatures below 0° C. or by raising the pH using suitable bases, examples being alkali metal or alkaline earth metal hydroxides.

For further working, a fraction of the water/alcohol mixture and of the volatile acids can be separated from the reaction mixture, by means of distillation, for example.

In addition it has proven advantageous, after the main condensation has been terminated, for example, by raising of the pH and by addition of amides, to condense the silane precondensates to the aforementioned degrees of polymerization by storage at temperatures in the range from 0 to 50° C., preferably 10 to 40° C. The storage time is dependent on the duration of the main condensation. Generally speaking the reaction mixture is stored for 1 to 25 days, preferably 5 to 17 days, before the fluorinated silane compounds of formula (II) are added, without any intention that this should constitute a restriction.

The water content of the mixture formed in the condensation of compounds of formula (I), at the point when compounds of the formula (II) are added, is generally not critical. In general this value is situated preferably in the range from 11% to 14% by weight, in particular from 12% by weight to 13% by weight.

According to one particular aspect of the present invention the Brookfield viscosity of the mixture that is formed in the condensation of compounds of formula (I), at the point when compounds of the formula (II) are added, is in the range from 4.2 to 7.6 mPa*s, without any intention that should constitute a restriction.

The antigraffiti action is achieved by adding compounds of the formula (II)
(R″)ᵤSi(R′)ₜ(OR)₍₄₋ₜ₋ᵤ₎ (II)
in which R″ is a group containing 1 to 20 carbon atoms and having at least 3, preferably at least 5 and more preferably at least 7 fluorine atoms, u is 1 or 2 and t is 0 or 1, R and R′ are identical or different and are a group containing 1 to 20 carbon atoms.

Preferably the radical R″ is a linear or branched alkyl group or a cycloalkyl groups having 1 to 20, preferably 3 to 18, carbon atoms, which includes, in particular, 3, 5, 7, 9, 11, 13 or 15 fluorine atoms. In this case the silicon atom and the fluorine atoms are preferably separated by at least three, in particular at least four bonds.

According to one particular embodiment of the present invention, as fluorinated silanes, compounds of the formula (VI)
F₃C(CF₂)ᵣ(CH₂)ₛSi(R′)ₜ(OR)₍₃₋ₜ₎ (VI)
in which r is an integer from 0 to 18, s is an integer from 0 to 2 and t is 0 or 1, R and R′ are identical or different and are a group containing 1 to 20 carbon atoms, preferably a linear or branched alkyl group having 1 to 10, in particular 1 to 4, carbon atoms, are.

The preferred fluorinated silanes of the formula (II) include, among others, n-trifluoropropyltrimethoxysilane, n-trifluoropropyltriethoxysilane, isotrifluoropropyltriethoxysilane, isotrifluoropropyltrimethoxysilane, isoheptafluoropropyltripropoxysilane, n-heptafluoropropyltriethoxysilane, isoheptafluoropropyltriethoxysilane, isoheptafluoropropyltrimethoxysilane, n-pentafluorobutyltrimethoxysilane, n-nonapentafluorobutyltrimethoxysilane, n-pentafluorobutyltriethoxysilane, n-nonapentafluorobutyltriethoxysilane, n-heptafluoropentyltrimethoxysilane, n-nonahexyltrimethoxysilane, 3,3,4,4,5,5,6,6,7,7,8,8,8-tridecafluorooctyltrimethoxysilane, 3,3,4,4,5,5,6,6,7,7,8,8,8-tridecafluorooctyltriethoxysilane, 3,3,4,4,5,5,6,6,7,7,8,8,9,9,9-pentadecafluorononyltrimethoxysilane and 3,3,4,4,5,5,6,6,7,7,8,8,9,9,9-pentadecafluorononyltriethoxysilane

The amount of compounds of the formula (II) can be situated within wide ranges, the values being dependent on the desired surface energy and also on the amount of solvent. In general 0.01% to 10% by weight, in particular 0.1 to 5% by weight, of fluorinated silanes, based on the total weight of the mixture after the fluorinated silanes have been added, are added to the reaction mixture.

In the case of lower amounts it is in many cases not possible to lower the surface energy sufficiently. If larger amounts are used the adhesion of the cured coating to the plastics substrate is in many cases too low.

Before or after the addition of the fluorinated silanes it is possible to use suitable organic solvents, such as alcohols, for example, such as ethanol, methanol, isopropanol, butanol, ethers, such as diethyl ether, dioxane, ethers and esters of polyols, such as, for example, ethylene glycol, propylene glycol, and also ethers and esters of these compounds, hydrocarbons, e.g., aromatic hydrocarbons, ketones, such as acetone, methyl ethyl ketone, for example, to adjust the solids content to about 15%-35% by weight, based on the total weight of the mixture. Particular preference as solvent is given to ethanol and/or propan-2-ol and hexanol.

It has additionally proven advantageous to add to the coating agents solvents which normally effect partial dissolution of the plastic envisaged as substrate for the coating. In the case of polymethyl methacrylate (PMMA) as substrate, for example, it is advisable to add solvents, such as toluene, acetone, tetrahydrofuran, in amounts which make up 2% to 20% by weight, based on the total weight of the agents. The water content is generally adjusted to 5%-20% by weight, preferably to 11% to 15% by weight, based on the total weight of the agents.

In order to improve the storage properties it is possible to adjust the pH of the water-containing siloxane coating materials to a range of 3-6, preferably between 4.5 and 5.5. For this purpose it is also possible, for example, to add additives, especially propionamide, which are described in EP-A-0 073 911.

The siloxane coating materials which can be used in accordance with the invention can comprise curing catalysts, in the form for example of zinc compounds and/or other metal compounds, such as cobalt compounds, copper compounds or calcium compounds, lead particularly the octoates or naphthenates thereof. The fraction of the curing catalysts is generally 0.1%-2.5% by weight, especially 0.2%-2% by weight, based on the overall siloxane coating material, without any intention that this should constitute a restriction. Particular mention may be made, for example, of zinc naphthenate, zinc octoate, zinc acetate, zinc sulfate, etc.

Following the addition of the fluorinated silanes to the polysiloxanes, which have a degree of polymerization in the above-described range, the siloxane coating materials can be applied to plastics substrates and cured, to give plastic bodies with an antigraffiti effect. Furthermore, following the addition of the fluorinated silanes, the coating agents of the invention can be stored, the storage time being dependent, among other things, on the storage conditions, such as temperature and humidity, the amount of curing catalysts or additives for increasing the storage properties, and also the NMR-determinable degree of condensation of the polysiloxanes prior to addition of the fluorinated silanes. In general the coating agent can be stored for at least 20 days, preferably at least 10 days.

Plastic substrate suitable for the purposes of the present invention are known per se. Substrates of this kind include, in particular, polycarbonates, polystyrenes, polyesters, polyethylene terephthalate (PET) and polybutylene terephthalate (PBT) for example, cycloolefinic polymers (COCs) and/or poly(meth)acrylates. Preference is given here to polycarbonates, cycloolefinic polymers and poly(meth)acrylates, with poly(meth)acrylates being particularly preferred.

Polycarbonates are known in the art. Polycarbonates can be considered formally as polyesters of carbonic acid and aliphatic or aromatic dihydroxy compounds. They are readily accessible through reaction of diglycols or bisphenols with phosgene and/or carbonic diesters in polycondensation or transesterification reactions, respectively.

Preference is given here to polycarbonates which derive from bisphenols. These bisphenols include, in particular, 2,2-bis(4-hydroxyphenyl)propane (bisphenol A), 2,2-bis(4-hydroxyphenyl)butane (bisphenol B), 1,1-bis(4-hydroxyphenyl)cyclohexane (bisphenol C), 2,2′-methylenediphenol (bisphenol F), 2,2-bis(3,5-dibromo-4-hydroxyphenyl)propane (tetrabromobisphenol A) and 2,2-bis(3,5-dimethyl-4-hydroxyphenyl)propane (tetramethylbisphenol A).

Aromatic polycarbonates of this kind are customarily prepared by interfacial polycondensation or trans-esterification, details being set out in Encycl. Polym. Sci. Engng. 11, 648-718.

In the case of interfacial polycondensation the bisphenols are emulsified as an aqueous, alkaline solution in inert organic solvents, such as methylene chloride, chlorobenzene or tetrahydrofuran, for example, and are reacted in a staged reaction with phosgene. Catalysts employed include amines, and also phase transfer catalysts in the case of sterically hindered bisphenols. The resulting polymers are soluble in the organic solvents used.

Via the choice of the bisphenols it is possible to vary widely the properties of the polymers. If different bisphenols are used at the same time, block polymers can also be constructed in multistage polycondensations.

Cycloolefinic polymers are polymers obtainable using cyclic olefins, especially polycyclic olefins.

Cyclic olefins comprise, for example, monocyclic olefins, such as cyclopentene, cyclopentadiene, cyclohexene, cycloheptene, cyclooctene, and also alkyl derivatives of these monocyclic olefins having 1 to 3 carbon atoms, such as methyl, ethyl or propyl, such as, for example, methylcyclohexene or dimethylcyclohexene, and also acrylate and/or methacrylate derivatives of these monocyclic compounds. In addition it is also possible to use cycloalkanes having olefinic side chains as cyclic olefins, such as cyclopentyl methacrylate, for example.

Preference is given to bridged polycyclic olefin compounds. These polycyclic olefin compounds may have the double bond either in the ring, in which case they are bridged polycyclic cycloalkenes, or in side chains.

In that case they are vinyl derivatives, allyloxycarboxy derivatives and (meth)acryloyloxy derivatives of polycyclic cycloalkane compounds. These compounds may additionally contain alkyl, aryl or aralkyl substituents.

Exemplary polycyclic compounds, without any intention that this should constitute a restriction, are bicyclo[2.2.1]hept-2-ene(norbornene), bicyclo[2.2.1]hept-2,5-diene(2,5-norbornadiene), ethylbicyclo[2.2.1]hept-2-ene(ethylnorbornene), ethylidenebicyclo[2.2.1]hept-2-ene(ethylidene-2-norbornene), phenylbicyclo[2.2.1]hept-2-ene, bicyclo-[4.3.0]nona-3,8-diene, tricyclo[4.3.0.1^{2,5}]-3-decene, tricyclo[4.3.0.1^{2,5}]-3,8-decene-(3,8-dihydrodicyclopentadiene), tricyclo[4.4.0.1^{2,5}]-3-undecene, tetracyclo[4.4.0.1^{2,5},1^{7,10}]-3-dodecene, ethylidenetetracyclo[4.4.0.1^{2,5},1^{7,10}]-3-dodecene, methyloxycarbonyltetracyclo[4.4.0.1^{2,5},1^{7,10}]-3-dodecene, ethylidene-9-ethyltetracyclo[4.4.0.1^{2,5}1^{7,10}]-3-dodecene, pentacyclo-[4.7.0.1^{2,5},0^{3,13},1^{9,12}]-3-pentadecene, pentacyclo-[6.1.1^{3,6},0^{2,7}, 0^{9,13}]-4-pentadecene, hexacyclo-[6.6.1.1^{3,6}, 1^{10,13}, 0^{2,7}, 0^{9,14}]-4-heptadecene, dimethylhexacyclo[6.6.1.1^{3,6}, 1^{10,13}, 0^{2,7}, 0^{9,14}]-4-heptadecene, bis(allyloxycarboxy)tricyclo[4.3.0.1^{2,5}]decane, bis(methacryloxy)tricyclo[4.3.0.1^{2,5}]decane, bis(acryloyloxy)tricyclo[4.3.0.1^{2,5}]decane.

The cycloolefinic polymers are prepared using at least one of the above-described cycloolefinic compounds, particularly the polycyclic hydrocarbon compounds.

Furthermore, for the preparation of the cycloolefinic polymers, it is possible to use further olefins which can be copolymerized with the cycloolefinic monomers stated above. These include, among others, ethylene, propylene, isoprene, butadiene, methylpentene, styrene and vinyltoluene.

The majority of the abovementioned olefins, including in particular the cycloolefins and polycycloolefins, can be obtained commercially. Moreover, many cyclic and polycyclic olefins are obtainable by means of Diels-Alder addition reactions.

The cycloolefinic polymers can be prepared in conventional manner, as set out, inter alia, in Japanese patents 11818/1972, 43412/1983, 1442/1986 and 19761/1987 and in Japanese laid-out specifications Nos 75700/1975, 129434/1980, 127728/1983, 168708/1985, 271308/1986, 221118/1988 and 180976/1990 and in European patent applications EP-A-0 6 610 851, EP-A-0 6 485 893, EP-A-0 6 407 870 and EP-A-0 6 688 801.

The cycloolefinic polymers can be polymerized, for example, using aluminum compounds, vanadium compounds, tungsten compounds or boron compounds as catalyst in a solvent.

It is assumed that the polymerization can take place with ring opening or with opening of the double bond, depending on the conditions, in particular on the catalyst employed.

Additionally it is possible to obtain cycloolefinic polymers by means of free-radical addition polymerization, using light or an initiator as free-radical-forming agent. This is so in particular for the acryloyl derivatives of the cycloolefins and/or cycloalkanes. This type of polymerization can take place both in solution and in bulk (without solvent).

Another preferred plastics substrate comprises poly(meth)acrylates. These polymers are generally obtained by free-radical addition polymerization of mixtures which include (meth)acrylates. The expression (meth)acrylates embraces methacrylates and acrylates and also mixtures of both.

These monomers are widely known. They include, among others, (meth)acrylates which derive from saturated alcohols, such as methyl acrylate, ethyl(meth)acrylate, propyl(meth)acrylate, n-butyl (meth)acrylate, tert-butyl(meth)acrylate, pentyl (meth)acrylate and 2-ethylhexyl(meth)acrylate, for example; (meth)acrylates which derive from unsaturated alcohols, such as oleyl(meth)acrylate, 2-propynyl (meth)acrylate, allyl(meth)acrylate and vinyl (meth)acrylate, for example; aryl(meth)acrylates, such as benzyl(meth)acrylate or phenyl(meth)acrylate, it being possible for the aryl radicals to be in each case unsubstituted or substituted up to four times; cycloalkyl(meth)acrylates, such as 3-vinylcyclohexyl(meth)acrylate, bornyl(meth)acrylate; hydroxylalkyl(meth)acrylates, such as 3-hydroxypropyl(meth)acrylate, 3,4-dihydroxybutyl(meth)acrylate, 2-hydroxyethyl(meth)acrylate, 2-hydroxypropyl (meth)acrylate; glycol di(meth)acrylates, such as 1,4-butanediol di(meth)acrylate, (meth)acrylates of ether alcohols, such as tetrahydrofurfuryl(meth)acrylate, vinyloxyethoxyethyl(meth)acrylate; amides and nitriles of (meth)acrylic acid, such as N-(3-dimethylaminopropyl)(meth)acrylamide, N-(diethylphosphono)(meth)acrylamide, 1-methacryloylamido-2-methyl-2-propanol; sulfur-containing methacrylates, such as ethylsulfinylethyl(meth)acrylate, 4-thiocyanatobutyl(meth)acrylate, ethylsulfonylethyl(meth)acrylate, thiocyanatomethyl(meth)acrylate, methylsulfinylmethyl(meth)acrylate, bis((meth)acryloyloxyethyl)sulfide; polyfunctional(meth)acrylates, such as trimethyloylpropanetri(meth)acrylate, pentaerythritoltetra(meth)acrylate and pentaerythritoltri(meth)acrylate.

According to one preferred aspect of the present invention these mixtures contain at least 40% by weight, preferably at least 60% by weight and more preferably at least 80% by weight, based on the weight of the monomers, of methyl (meth)acrylate.

Besides the (meth)acrylates set out above it is also possible for the compositions to be polymerized to contain further unsaturated monomers which are copolymerizable with methyl (meth)acrylate and with the abovementioned (meth)acrylates.

These additional monomers include 1-alkenes, such as hex-1-ene, hept-1-ene; branched alkenes, such as vinylcyclohexane, 3,3-dimethyl-1-propene, 3-methyl-1-diisobutylene, 4-methylpent-1-ene, for example;

acrylonitrile; vinyl esters such as vinyl acetate; styrene, substituted styrenes having an alkyl substituent in the side chain, such as α-methylstyrene and α-ethylstyrene, for example, substituted styrenes having an alkyl substituent on the ring, such as vinyl toluene and p-methylstyrene, halogenated styrenes, such as monochlorostyrenes, dichlorostyrenes, tribromostyrenes and tetrabromostyrenes, for example;

heterocyclic vinyl compounds, such as 2-vinylpyridine, 3-vinylpyridine, 2-methyl-5-vinylpyridine, 3-ethyl-4-vinylpyridine, 2,3-dimethyl-5-vinylpyridine, vinylpyrimidine, vinylpiperidine, 9-vinylcarbazole, 3-vinylcarbazole, 4-vinylcarbazole, 1-vinylimidazole, 2-methyl-1-vinylimidazole, N-vinylpyrrolidone, 2-vinylpyrrolidone, N-vinylpyrrolidine, 3-vinylpyrrolidine, N-vinylcaprolactam, N-vinylbutyrolactam, vinyloxolane, vinylfuran, vinylthiophene, vinylthiolane, vinylthiazoles and hydrogenated vinylthiazoles, vinyloxazoles and hydrogenated vinyloxazoles;

vinyl ethers and isoprenyl ethers; maleic acid derivatives, such as maleic anhydride, methyl maleic anhydride, maleimide and methylmaleimide, for example; and

dienes, such as divinylbenzene, for example.

Generally these comonomers are used in an amount of 0 to 60% by weight, preferably 0 to 40% by weight and more preferably 0 to 20% by weight, based on the weight of the monomers, it being possible to use the compounds individually or as a mixture.

The polymerization is generally initiated using known free-radical initiators. The preferred initiators include, among others, the azo initiators which are widely known in the art, such as AIBN and 1,1-azobiscyclohexanecarbonitrile, and also peroxy compounds, such as methyl ethyl ketone peroxide, acetyl acetone peroxide, dilauryl peroxide, tert-butyl per-2-ethylhexanoate, ketone peroxide, methyl isobutyl ketone peroxide, cyclohexanone peroxide, dibenzoyl peroxide, tert-butyl peroxybenzoate, tert-butylperoxyisopropyl carbonate, 2,5-bis(2-ethylhexanoylperoxy)-2,5-dimethylhexane, tert-butyl peroxy-2-ethylhexanoate, tert-butyl peroxy-3,5,5-trimethylhexanoate, dicumyl peroxide, 1,1-bis(tert-butylperoxy)cyclohexane, 1,1-bis(tert-butylperoxy)-3,3,5-trimethylcyclohexane, cumyl hydroperoxide, tert-butyl hydroperoxide, bis(4-tert-butylcyclohexyl)peroxydicarbonate, mixtures of two or more of the aforementioned compounds with one another, and also mixtures of the aforementioned compounds with compounds not mentioned which can likewise form free radicals.

These compounds are used frequently in an amount of 0.01% to 10% by weight, preferably of 0.5% to 3% by weight, based on the weight of the monomers.

The aforementioned polymers can be used individually or as a mixture. In this context it is also possible to use different polycarbonates, poly(meth)acrylates or cycloolefinic polymers, which differ, for example, in the molecular weight or in the monomer composition.

The plastics substrates of the invention can be produced, for example, from molding compounds of the aforementioned polymers. In this context use is made generally of thermoplastic shaping methods, such as extrusion or injection molding.

The weight average of the molecular weight, M_{W}, of the homopolymers and/or copolymers for use in accordance with the invention as a molding compound for producing the plastics substrates can fluctuate within wide ranges, the molecular weight usually being brought into line with the intended application and the manner of processing of the molding compound. Generally speaking, however, the molecular weight is situated in the range between 20 000 and 1 000 000 g/mol, preferably 50 000 to 500 000 g/mol and more preferably 80 000 to 300 000 g/mol, without any intention that this should constitute a restriction. This parameter can be determined for example by means of gel permeation chromatography.

It is also possible for the plastics substrates to be produced by cell casting processes. In this case, by way of example, suitable (meth)acrylic mixtures are placed in a mold and polymerized. (Meth)acrylic mixtures of this kind generally include the (meth)acrylates set above, particularly methyl methacrylate. The (meth)acrylic mixtures may further comprise the copolymers set out above, and also, in particular for the purpose of adjusting the viscosity, may comprise polymers, especially poly(meth)acrylates.

The weight average of the molecular weight, M_{W}, of the polymers produced by cell casting processes is generally higher than the molecular weight of polymers which are used in molding compounds. This produces a series of known advantages. Generally speaking the weight average of the molecular weight of polymers produced by cell casting processes is situated in the range from 500 000 to 10 000 000 g/mol, without any intention that this should constitute a restriction.

Preferred plastics substrates can be obtained commercially from Röhm GmbH & Co. KG under the trade name ®Plexiglas GS and XT.

Furthermore, the molding compounds used for producing the plastics substrates, and also the acrylic resins, may comprise additives of all kinds. These include, among others, antistats, antioxidants, mold release agents, flame retardants, lubricants, dyes, flow improvers, fillers, light stabilizers and organophosphorus compounds, such as phosphites, phosphorinanes, phospholanes or phosphonates, pigments, weathering stabilizers and plasticizers. The amount of additives, however, is restricted with respect to the intended application.

Particularly preferred molding compositions comprising poly(meth)acrylates are available commercially under the trade name PLEXIGLAS® from Degussa AG. Preferred molding compounds comprising cycloolefinic polymers can be obtained under the trade name ®Topas from Ticona and ®Zeonex from Nippon Zeon. Polycarbonate molding compounds are obtainable, for example, under the trade name ®Makrolon from Bayer or ®Lexan from General Electric.

With particular preference the plastics substrate comprises at least 80% by weight, in particular at least 90% by weight, based on the total weight of the substrate, of poly(meth)acrylates, polycarbonates and/or cycloolefinic polymers. With particular preference the plastics substrates are composed of polymethyl methacrylate, it being possible for the polymethyl methacrylate to include customary adjuvants.

According to one preferred embodiment it is possible for plastics substrates to have an impact strength to ISO 179/1 of at least 10 kJ/m², preferably at least 15 kJ/m².

The shape and the size of the plastics substrate are not critical to the present invention. Generally speaking, substrates of sheet or panel form are frequently used, having a thickness in the range from 1 mm to 200 mm, particularly 3 to 25 mm.

Before the plastics substrates are provided with a coating, they may be activated by suitable methods in order to promote the adhesion. This can be done, for example, by treating the plastics substrate with a chemical and/or physical method, the particular method being dependent on the plastics substrate.

Depending on the plastics substrate, the adhesiveness of the siloxane coating on the substrate can be enhanced by applying primer coatings, the use and nature of the primer coat as a function of plastics substrate being familiar to the skilled worker for the purpose of promoting the adhesion of siloxane coatings.

The siloxane coating materials set out above can be applied to the plastics substrate by any known method. Such methods include, among others, dip methods, spray methods, knife coating, flow coating, roller application or roll application.

The siloxane coating materials thus applied can generally be cured to coatings featuring outstanding scratch resistance and adhesiveness, within a relatively short time, such as within 2 to 6 hours, for example, generally within about 3 to 5 hours, and at a comparatively low temperature, at 70-110° C. for example, preferably at about 80° C.

The film thickness of the siloxane coating is relatively uncritical. In general, however, this parameter after curing is situated in a range from 1 to 50 μm, preferably 1.5 to 30 μn and more preferably 3 to 15 μm, without any intention that this should constitute a restriction. The film thicknesses can be determined by means of a micrograph taken using a scanning electron microscope (SEM).

The moldings of the present invention provided with a scratch-resistant, dirt-repellant coating exhibit a high scratch resistance. The increase in haze after a scratch resistance test to DIN 52 347 E (applied force=5.4 N, number of cycles=100) is preferably not more than 20%, more preferably not more than 15% and very preferably not more than 11%.

According to one particular aspect of the present invention the plastic body is transparent, the transparency τ_{D65/10} to DIN 5033 being at least 70%, preferably at least 75%.

The plastic body preferably has an elasticity modulus to ISO 527-2 of at least 1000 MPa, in particular at least 1500 MPa, without any intention that this should constitute a restriction.

The plastic bodies of the invention are generally very stable to weathering. Thus the weathering stability to DIN 53387 (Xenotest) is at least 5000 hours.

Even after long UV irradiation of more than 5000 hours, the yellowness index to DIN 6167 (D65/10) of preferred plastic bodies is less than or equal to 8, preferably less than or equal to 5, without any intention that this should constitute a restriction.

The cured coating preferably has a fluorine content in the range from 0.005% to 20% by weight, in particular in the range from 0.01 to 10% by weight and more preferably in the range from 0.1% to 5% by weight, based on the total weight of the coating. According to one particular embodiment of the present invention the coating of the plastic body exhibits a fluorine content, measured on the surface by ESCA spectroscopy, in the range from 2 to 14, in particular from 3 to 12, atom %, based on the sum of the elements fluorine, silicon, carbon and oxygen, of the coating composition of the surface. Preferably the fluorine content at the surface is higher than at the side of the coating facing the plastics substrate. With particular preference the fluorine content of the siloxane coating at the boundary with the plastics substrate or with any primer coat is less than or equal to 80%, based on the fluorine content at the surface, with very particular preference less than or equal to 60%, based on the fluorine content at the surface.

According to one particular aspect of the present invention the silicon content of the coating at the surface, measured by ESCA spectroscopy, is preferably in the range from 15 to 25, in particular 18 to 22, atom %, based on the sum of the elements fluorine, silicon, carbon and oxygen.

The carbon content of the surface, measured by ESCA spectroscopy, is preferably in the range from 25 to 55 atom %, in particular 30 to 45 atom %, based on the sum of the elements fluorine, silicon, carbon and oxygen.

ESCA spectroscopy is known, this method being described, for example, in Journal of Catalysis Vol. 176, 561-568 (1998) SIMS/XPS, “Study on Deactivation and Reactivation of B-MFI Catalysts Used in the Vapour-Phase Beckmann Rearrangement” by P. Albers et al. and in GIT Fachz. Lab. 33 (1989) 637-644, 706-710, “Oberflächenanalytik” [Surface analysis] by K. Seibold and P. Albers.

The antigraffiti effect is achieved by hydro-phobicization of the siloxane coating. This is reflected in a low surface energy. According to one particular aspect of the present invention the surface energy after the curing of the siloxane layer is preferably not more than 40 mN/m, in particular not more than 35 mN/m and more preferably not more than 28 mN/m, without any intention that this should constitute a restriction.

The surface energy is determined by the Ownes-Wendt-Rabel & Kaeble method. For this purpose, series of measurements are carried out using the Busscher standard series, in which the test liquids used are water [SFT 72.1 mN/m], formamide [SFT 56.9 mN/m], diiodomethane [SFT 50.0 mN/m] and alpha-bromonaphthalene [SFT 44.4 mN/m]. The measurement is carried out at 20° C. The surface tension and the polar and disperse components of these test liquids are known and are used to calculate the surface energy of the substrate.

Furthermore, the hydrophobicization of the siloxane coating can be ascertained from the contact angle formed by a drop of alpha-bromonaphthalene or water on the siloxane surface. According to one particular aspect of the present invention the contact angle at 20° of alpha-bromonaphthalene with the surface of the plastic body after curing of the scratch-resistant coating is preferably at least 50°, in particular at least 70° and more preferably at least 75°, without any intention that this should constitute a restriction.

The contact angle with water at 20° C. according to one particular embodiment is preferably at least 800, in particular at least 90° and more preferably at least 100°.

According to one preferred embodiment the contact angle of alpha-bromonaphthalene with the siloxane surface is not more than 70°, preferably not more than 60°. The measurement is carried out at 20° C.

The surface energy can be determined using a G40 contact angle measurement system from Krüss, Hamburg, the procedure being described in the user manual for the G40 contact angle measurement system, 1993. With regard to the calculation methods, reference may be made to A. W. Neumann, Über die Messmethodik zur Bestimmung grenzflächenenergetischer Gröβen [Measurement methodology for determining surface energy variables], Part I, Zeitschrift für Phys. Chem., Vol. 41, pp. 339-352 (1964), and A. W. Neumann, Über die Messmethodik zur Bestimmung grenzflächenenergetischer Gröβen [Measurement methodology for determining surface energy variables], Part II, Zeitschrift für Phys. Chem., Vol. 43, pp. 71-83 (1964).

The plastic bodies of the present invention may serve, for example, in the construction sector, particularly for producing glasshouses or conservatories, or as a noise barrier wall.

The invention is elucidated in more detail below by means of inventive and comparative examples, without any intention that the invention should be restricted to these inventive examples.

### INVENTIVE EXAMPLES 1 to 4

250 g of methyltriethoxysilane (MTES), 91.5 g of DI water and 12.5 g of acetic acid were charged to a glass beaker, stirred for 1 hour and left to stand at room temperature for 24 hours. Then 18.5 g of propionamide, 1.55 g of zinc octoate, 14.0 g of toluene and 2.15 g of a 10% strength KOH solution were added to the solution. Thereafter the amounts shown in Table 1 of a Dynasilan F8262 solution (10% strength) are added, after the times of 70.h hours to 420 hours likewise indicated in Table 1, to 40 g in each case (aliquot parts).

The MeSiO₂(OH) to MeSiO₃ ratio when the fluorosilane compounds were added was determined by means of NMR spectroscopy, the signals being assigned in accordance with F. Brunet, Journal of Non-Crystalline Solids 231 (1998), 58-77. The signal groups T1 (dihydroxysiloxane), T2 (hydroxydisiloxane) and T3 (trisiloxane) can be assigned to the end groups, monomer units in the chain, and branches and can be detected in a time-resolved manner. The fraction of the groups is given by the integrals of the NMR signals. For the purpose of evaluation a 1^{st}-order kinetics was assumed.

The mixtures obtained are applied by flow coating to a PMMA plastics substrate, in each case after a total of 18 days, and are cured thermally in a drying oven at 80° C. for 5 h.

To determine the dirt repellency effect, the coatings are sprayed with different coating materials. After 24 hours the coating is cleaned for about one minute using a high-pressure cleaner at 80° C.

It is apparent that the coating materials can be removed effectively from the coating. The paints used were yellow—prisma color acryl—and blue—prisma color acryl—from SchullerEh'klar GmbH, Austria, and also red—pinture paint spray, Montana Colors, S.L. Berlin.

The plate was subjected to a Taber test to DIN 52347 to determine the scratch resistance and also to a cross-cut to DIN 53151. The Taber test was carried out with an applied force of 5.4 N with 100 cycles using a “CS10F” abrasive wheel from the company Teledyne Taber.

TABLE 1

| | Time at which | | Taber test |
|---|---|---|---|
| Inventive | fluorine | MeSiO₂(OH)/ | (DIN 52347) |
| examples | compounds added | MeSiO₃ | delta haze |
| Example 1 | 70.5 | 2.25 | 14.8% |
| Example 2 | 175.0 | 1.71 | 10.4% |
| Example 3 | 300.0 | 1.51 | 9.7% |
| Example 4 | 420.0 | 1.36 | 10.1% |

### INVENTIVE EXAMPLES 5 to 8

Examples 1 to 4 were essentially repeated, but using a 30% Dynasylan solution. The results obtained are set out in Table 2.

For the purposes of determining the dirt repellency effect, the coatings were sprayed with different coating materials. After 24 hours the coating is cleaned for about one minute using a high-pressure cleaner at 80° C. It is apparent that the coating materials set out in inventive examples 1 to 4 can be removed very effectively from the coating.

TABLE 2

| | Time at which | | Taber test |
|---|---|---|---|
| Inventive | fluorine | MeSiO₂(OH)/ | (DIN 52347) |
| examples | compounds added | MeSiO₃ | delta haze |
| Example 5 | 70.5 | 2.25 | 17.2% |
| Example 6 | 175.0 | 1.71 | 18.6% |
| Example 7 | 300.0 | 1.51 | 18.6% |
| Example 8 | 420.0 | 1.36 | 18.6% |

### COMPARATIVE EXAMPLE 1

Inventive example 1 was essentially repeated, but the fluorine compounds (Dynasilan F8262 solution (10% strength)) were added after just 6.5 hours. The MeSiO₂(OH)/MeSiO₃ ratio at the point when the fluorine compounds were added was 6.22. The coating agent thus obtained was applied after 18 days. The flow was very poor, with the coating exhibiting no adhesion to the sheet. Accordingly, the delta haze value determined by the Taber test was about 37%, and it was virtually impossible to remove the coating materials listed in example 1 from the substrate.

### COMPARATIVE EXAMPLE 2

Inventive example 1 was essentially repeated, but the fluorine compounds (Dynasilan F8262 solution (10% strength)) were added not until after 1200 hours. The MeSiO₂(OH)/MeSiO₃ ratio at the point when the fluorine compounds were added was 0.45. The coating agent thus obtained was applied after the fluorine compound had been added. The flow was very poor, with the coating exhibiting no adhesion to the sheet. Accordingly, the delta haze value determined by the Taber test was about 37%, and it was virtually impossible to remove the coating materials listed in example 1 from the substrate.

1. A coating agent with an antigraffiti effect, obtained by subjecting organosilicon compounds of the general formula (I)
R¹ₙSiX₄₋ₙ (I),
wherein R¹ is a group comprising 1 to 20 carbon atoms, X is an alkoxy radical comprising 1 to 20 carbon atoms or a halogen, and n is an integer from 0 to 3,
it being possible for different radicals X or R¹ in each case to be identical or different, precondensates obtainable therefrom, or a combination thereof,
wherein at least 50% by weight of the silicon compounds, based on the total weight of the silicon compounds employed, are represented by the formula R¹SiX₃,
wherein R¹ and X are as defined above,
to condensation to give polysiloxanes,
until the ratio of R¹SiO(OH) to R¹SiO_{1.5} signals, measured by NMR spectroscopy, is in the range from 0.6 to 4, and
adding to the polysiloxanes compounds of the formula (II)
(R″)ᵤSi(R′)ₜ(OR)₍₄₋ₜ₋ᵤ₎ (II),
wherein R″ is a group comprising 1 to 20 carbon atoms and R″ further comprises at least 3 fluorine atoms,
u is 1 or 2, and
t is 0 or 1,
wherein R and R′ are identical or different and are a group comprising 1 to 20 carbon atoms.

2. The coating agent of claim 1, wherein the ratio of R¹SiO(OH) to R¹SiO_{1.5} signals, measured by NMR spectroscopy, is in the range from 0.8 to 3.5 of the polysiloxanes to which compounds of the formula (II) are added.

3. The coating agent of claim 1 wherein the water content of the polysiloxanes formed in the condensation of compounds of formula (I) at the point where compounds of the formula (II) are added is in the range from 11% to 14% by weight.

4. The coating agent of claim 1 wherein the Brookfield viscosity of the polysiloxanes formed in the condensation of compounds of formula (I) at the point where compounds of the formula (II) are added is in the range from 4.2 to 7.6 mPa*s.

5. The coating agent of claim 1 wherein the polysiloxanes to which compounds of the formula (II) are added have a hydroxyl group content which is in the range from 17% to 30%, based on the number of possible hydroxyl groups which can arise at maximum from the hydrolysis of compounds of the formula (I).

6. The coating agent of claim 5, wherein the hydroxyl group content of the polysiloxanes to which compounds of the formula (II) are added is in the range from 19% to 22%, based on the number of possible hydroxyl groups which can arise at maximum from the hydrolysis of compounds of the formula (I).

7. The coating agent of claim 1, wherein a composition comprising at least 80% by weight of alkyltrialkoxysilanes, based on the amount of organic silicon compounds of formula (I), is used as the organosilicon compounds.

8. The coating agent of claim 7, wherein the composition comprises at least 80% by weight of methyltrialkoxysilanes, based on the amount of organosilicon compounds of formula (I).

9. The coating agent of claim 1, wherein 0.01% to 10% by weight of compounds of the formula (II), based on the total weight of the polysiloxanes, are added to the mixture.

10. The coating agent of claim 1, wherein at least one acid is used for condensing the organosilicon compounds of formula (I).

11. The coating agent of claim 1, characterized in that the coating agent comprises at lest one amide.

12. The coating agent of claim 1, characterized in that the coating agent comprises at least one metal compound.

13. The coating agent of claim 12, wherein the at least one metal compound comprises zinc, cobalt, copper calcium, or a combination thereof.

14. The coating agent of claim 1, wherein the coating agent comprises at least one amine.

15. A plastic body, comprising a plastic substrate coated with the coating agent of claim 1, wherein the plastic substrate coated with the coating agent of claim 1 has been cured.

16. The plastic body of claim 15, characterized in that the plastic substrate comprises cycloolefin copolymers, polyethylene terephthalates, polycarbonates, poly(meth)acrylates, or a combination thereof.

17. The plastic body of claim 15, characterized in that the plastic substrate has an impact strength of at least 10 kJ/m² to ISO 179/1.

18. The plastic body of claim 15, characterized in that the plastic substrate has a thickness in the range from 1 mm to 200 mm.

19. The plastic body of claim 15, characterized in that the film thickness of the coating agent is in the range from 3 to 15 μm.

20. The plastic body of claim 15, characterized in that the increase in the haze value of the plastic body when a scratch resistance test is carried out to DIN 52347 is not more than 15%.

21. The plastic body of claim 15, characterized in that the plastic body has an elasticity modulus to ISO 527-2 of at least 1500 MPa.

22. The plastic body of claim 15, characterized in that the plastic body has a weathering stability to DIN 53 387 of at least 5000 hours.

23. The plastic body of claim 15, characterized in that the plastic body has a transparency to DIN 5033 of at least 70%.

24. The plastic body of claim 15, characterized in that the coating of the plastic body has a fluorine content, measured at the surface by ESCA spectroscopy, in the range from 2 to 14 atom %, based on the sum of the elements fluorine, silicon, carbon and oxygen.

25. The plastic body of claim 15, characterized in that a surface energy of plastic body has not more than 35 mN/m.

26. A method for the production of a plastic body, wherein the plastic body comprises a plastic substrate, and wherein the plastic body has an antigraffiti effect,
comprising
applying the coating agent of claim 1 is applied to a plastic substrates; and
curing the coated plastic substrate,
thereby producing the plastic body.
